(19) United States
(12) Patent Application Publication
(10) Pub. No.: US 2011/0177477 A1
(43) Pub. Date: Jul. 21, 2011

(54) DENTURE SYSTEM KIT AND METHOD

(76) Inventors: Paul D. RASKIN, Sacramento, CA (US); Jonah E. RASKIN, Sacramento, CA (US)

(21) Appl. No.: 13/073,183

(22) Filed: Mar. 28, 2011

Related U.S. Application Data
(62) Division of application No. 11/835,915, filed on Aug. 8, 2007.
(60) Provisional application No. 60/836,123, filed on Aug. 8, 2006.

(51) Int. Cl. A61C 13/02

(52) U.S. Cl. 433/200.1

(57) ABSTRACT

To fabricate a new denture from an existing denture, the existing denture for a patient is sensed. The existing denture corresponds to one or more of a mandibular edentulous ridge, maxillary edentulous ridge, and palate of the patient. In addition, a model is generated of the one or more of the mandibular edentulous ridge, maxillary edentulous ridge, and palate and a wax arch of teeth is modulated in response to a sensed arch of the existing denture. Furthermore, a wax up is generated corresponding to the existing denture by filling a gap between the wax arch and the model and the new denture is fabricated corresponding to the existing denture by investment casting the wax up.

### CROSS REFERENCE TO RELATED APPLICATIONS

This present application is a Divisional of U.S. patent application Ser. No. 11/835,915, filed Aug. 8, 2007, which in turn claims the benefit of priority to U.S. Provisional Application Ser. No. 60/836,123, filed on Aug. 8, 2006, titled “DENTURE SYSTEM KIT AND METHOD,” the disclosures of both of which are incorporated herein by reference in their entirety.

### FIELD OF THE INVENTION

The present invention generally relates to a system, kit, and method of fabricating dentures. More particularly, the present invention pertains to a system and kit for fabricating dentures from existing dentures and method of fabricating dentures.

### BACKGROUND OF THE INVENTION

Various devices are known in the art for forming casts of dentures. Generally speaking, such devices merely form a cast of a denture without taking into consideration any wear that the denture may have been subjected to. A considerable amount of manual work must be made in order to reproduce a denture having the patient's exact measurements. Reference must be made back to the patient. Thus, such prior art techniques involve considerable trial and error and reference back to the patient to see if the dentures being reproduced are proper. Also, such prior art devices do not provide for means for changing the orientation of a denture being reproduced so as to make new dentures having different dimensional relationships.

Accordingly, it is desirable to provide a system and kit for fabricating dentures from existing dentures and method of fabricating dentures that is capable of overcoming the disadvantages described herein at least to some extent.

### SUMMARY OF THE INVENTION

The foregoing needs are met, to a great extent, by the present invention, wherein in some embodiments a system and kit for fabricating dentures from existing dentures and method of fabricating dentures is provided.

An embodiment of the present invention relates to a patient kit for generating a set of dentures from an existing set of dentures. The patient kit includes an impression material, bite registration material, dental gypsum, tracing plate, wax pattern, fill wax, investing material, tooth resin, and denture base resin. The impression material is to generate an impression corresponding to a mandibular edentulous ridge, maxillary edentulous ridge, and palate of a patient. The bite registration material is to generate a bite registration impression corresponding to a relative position of the existing dentures in the patient's mouth and thereby locate the position of the patient's mandibular edentulous ridge relative to the patient's maxillary edentulous ridge. The dental gypsum provides a support structure for a model of the patient's mandibular edentulous ridge, maxillary edentulous ridge and palate. The tracing plate provides a surface to trace an arch of the existing dentures. The wax pattern corresponds to an arch of teeth. The fill wax is to fill voids between the wax pattern and the model. The investing material is to generate a mold to fabricate the dentures. The tooth resin is to fill a tooth portion of the mold. The denture base resin is to fill a base portion of the mold.

Another embodiment of the present invention pertains to a patient kit for generating a clinical impression corresponding to an existing set of dentures. The patient kit includes an impression material, bite registration material, dental gypsum, and tracing plate. The impression material is to generate an impression corresponding to a mandibular edentulous ridge, maxillary edentulous ridge, and palate of a patient. The bite registration material is to generate a bite registration impression corresponding to a relative position of the existing dentures in the patient's mouth and thereby locate the position of the patient's mandibular edentulous ridge relative to the patient's maxillary edentulous ridge. The dental gypsum provides a support structure for a model of the patient's mandibular edentulous ridge, maxillary edentulous ridge and palate. The tracing plate provides a surface to trace an arch of the existing dentures.

Another embodiment of the present invention relates to a patient kit for generating a clinical impression and a wax denture corresponding to a patient's mandibular edentulous ridge, maxillary edentulous ridge, and palate. The patient kit includes an impression material, bite registration material, dental gypsum, tracing plate, wax pattern, and fill wax. The impression material is to generate an impression corresponding to the mandibular edentulous ridge, maxillary edentulous ridge, and palate of the patient. The bite registration material is to generate a bite registration impression corresponding to a relative position of the patient's mandibular edentulous ridge relative to the patient's maxillary edentulous ridge. The dental gypsum is to provide a support structure for a model of the patient's mandibular edentulous ridge, maxillary edentulous ridge and palate. The tracing plate provides a surface to trace an arch of the patient's existing denture teeth. The wax pattern corresponds to an arch of teeth. The fill wax is to fill voids between the wax pattern and the model.

Another embodiment of the present invention pertains to a patient kit for generating a set of dentures from a given clinical impression and patient model, the clinical impression and patient model being based upon an existing set of dentures. The patient kit includes a wax pattern, fill wax, investing material, tooth resin, and denture base resin. The wax pattern corresponds to an arch of teeth. The fill wax is to fill voids between the wax pattern and the patient model. The investing material is to generate a mold to fabricate the dentures. The tooth resin is to fill a tooth portion of the mold. The denture base resin is to fill a base portion of the mold.

Another embodiment of the present invention relates to a method of fabricating a new denture from an existing denture. In this method an existing denture for a patient is sensed. The existing denture corresponds to one or more of a mandibular edentulous ridge, maxillary edentulous ridge, and palate of the patient. In addition, a model is generated of the one or more of the mandibular edentulous ridge, maxillary edentulous ridge, and palate and a wax arch of teeth is modulated in response to a sensed arch of the existing denture. Furthermore, a wax up is generated corresponding to the existing denture by filling a gap between the wax arch and the model and the new denture is fabricated corresponding to the existing denture by investment casting the wax up.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of apparatus for making dentures in accordance with an embodiment of the invention.

FIG. 2 is a bottom view of the apparatus of FIG. 1.

FIG. 3 is a rear view of the apparatus of FIG. 1.

FIG. 4 is a top plan view of the apparatus with articulating member shown in down position.

FIG. 5 is a rear vertical view with articulating member shown in down position.

FIG. 6 is a plan view of a metal plate used with the device of FIGS. 1 to 5.

FIG. 7 is a perspective view of apparatus with paper and denture.

FIG. 8 is a side view of apparatus with paper, magnets and denture.

FIG. 9 is a block diagram of a patient kit that is suitable for use with the denture system and method of fabricating dentures.

FIG. 10 is a flow diagram for a method of fabricating a set of dentures according to an embodiment of the invention.

FIG. 11 is a perspective view of a wax pattern suitable for use with an embodiment according to FIG. 9.

FIG. 12 is a cut away view 12-12 of the wax pattern according to FIG. 11.

FIG. 13 is a perspective view of a mold suitable for use to generate the wax pattern according to FIG. 11.

FIG. 14 is a cut away view 14-14 of the mold shown in FIG. 13 according to an embodiment of the invention.

FIG. 15 is a cut away view 14-14 of the mold shown in FIG. 13 according to another embodiment of the invention.

FIG. 16 is a perspective view of a tracing plate and stage suitable for use with an embodiment of the invention.

### DETAILED DESCRIPTION

The present invention provides, in some embodiments, a denture fabrication system and patient kit for fabricating dentures from existing dentures and method of fabricating dentures. The system includes a suitable articulator, casting device, and a patient kit. The kit includes patterns and various materials to fabricate the dentures based on an existing set of dentures.

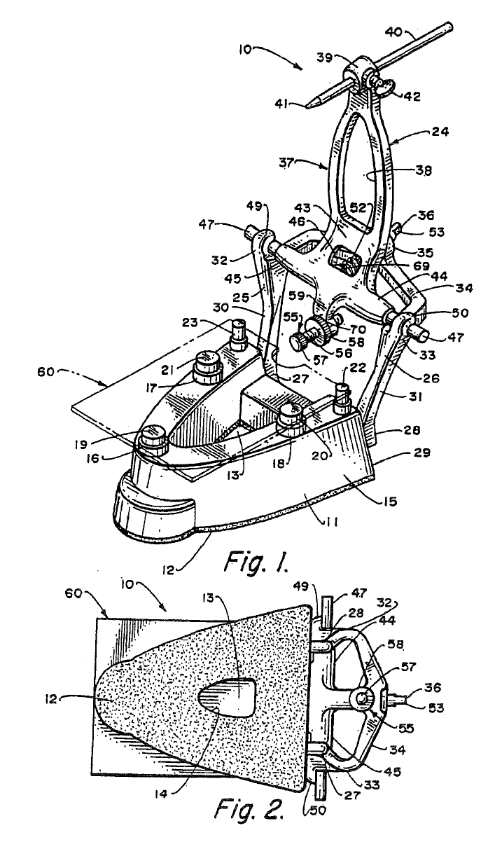

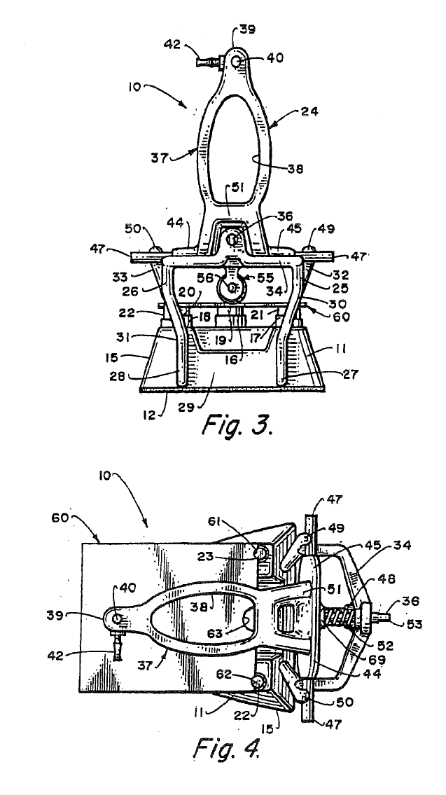

Referring now to FIG. 1 of the drawing, an articulator 10 is shown which is suitable for use in fabricating dentures according to an embodiment of the invention. The articulator 10 includes a main base 11 which, as seen particularly in FIG. 2, is generally triangular-shaped having a flat bottom surface 12 with an arcuate cut-out section 13 along linear edge 14 thereof. As seen in FIG. 3, base 11 has a tapered peripheral side 15 and the portion of base 11 at cut-out section 13 is lower in height than the remainder of base 11 optionally bottom 12 may be filled and felt covered.

A plurality of bosses, such as the three shown in FIG. 1 e.g. bosses 16 to 18, are provided at each one of the apices of base 11 on the upper surface thereof. As seen in FIG. 1, these bosses 16 to 18 have circular depressions loosely receiving therein a magnet, such as magnets 19 to 21, respectively. In addition, the upper surfaces of bosses 16 to 18 are also of magnetic material for reasons to be discussed. Rearwardly of each of the bosses 17, 18 a pair of vertically extending metal guide posts 22, 23 are provided on the upper surface of base 11.

An articulating member 24 is mounted to base 11. As particularly seen in FIGS. 2 and 3, member 24 includes a pair of vertical arms 25, 26 having bracket portions 27, 28 fixedly mounted to the rear wall 29 of base 11. Arms 25, 26 have first lower portions 30, 31 respectively extending upwardly from bracket portions 27, 28 with integral outwardly extending upper portions 32, 33 interconnected at the top by a U-shaped connecting bracket 34.

Bracket 34 has a central apertured boss 35 (see particularly FIG. 3) receiving a screw 36 therethrough (FIG. 1).

Articulating member 24 includes an articulating portion 37 (see also FIG. 3) comprised of an elongated oval shaped member having a centrally located oval or wishbone-shaped opening 38 with an extension portion 39 extending from the apex of the opening 38 as seen in FIG. 3.

As seen in FIG. 1, an incisal reference pin or probe 40, having a tapered probe point or tip 41, is mounted in a vertical aperture in extension portion 39. A thumb screw 42 (FIG. 3) is threaded in a threaded aperture in extension portion 39, extending normal to the vertical aperture in which probe 40 is mounted, so that screw 42 can be selectively tightened against probe 40 to retain it in extension portion 39, or loosened to allow removal of probe 40, or the vertical adjustment thereof.

As seen in FIGS. 1 and 3, portion 37 has a rearwardly downwardly sloping portion 43, extending from opening 38 (FIG. 1) with outwardly extending bosses 44, 45 on each side of portion 43 extending parallel to the elongated leg 48 of bracket 34. These bosses 44, 45 are apertured and aligned with a like opening in the rear arm 51 (FIG. 4) of sloping portion 43 (which has a cut-out portion 46—FIG. 3) the extending bosses 44, 45 each have pins 47 at both ends as a part of said extending bosses 44, 45, such as a metal pin, which also extends parallel to the elongated leg 48 of bracket 34. As seen in FIGS. 1 and 3, the upper portions 32, 33 of arms 25, 26, respectively, are preferably bifurcated forming branches 49, 50 respectively, which curve at the top, as shown in FIGS. 1 and 3, loosely trapping therein the pin 47 so that pin 47 is rotatable therein.

Thus, the articulating portion 37 pivots on pin 47 within branches 49, 50 see also FIG. 4.

As shown in FIG. 4, screw 36 has a head 69 abutting against the midpoint of rear arm 51, sliding in the opening in leg 48 (and enlarged at end 53 which acts as a stop). Since head 69 loosely abuts against arm 51, pulling back on spring 52 allows disengagement of head 69 from contact with arm 51 and removal of portion 37.

As seen in FIG. 5, a screw 55 is threaded in an aperture in an extension portion 59 extending rearwardly and downwardly from the rear arm 51 of portion 37. Screw 55 has a main threaded body 56 and a screw head 57. A knurled adjusting nut 58 is threaded on body 56 between portion 59 and head 57. The free or upper end of screw 55 bears against a boss 70 on arm 51 (FIG. 5).

It can be appreciated that knurled nut 58 can be adjusted to bear against portion 59 and against boss 70 thus raising articulating portion 37 (or loosened to lower portion 37) allowing for vertical adjustment which simulates the jaw hinge of a patient.

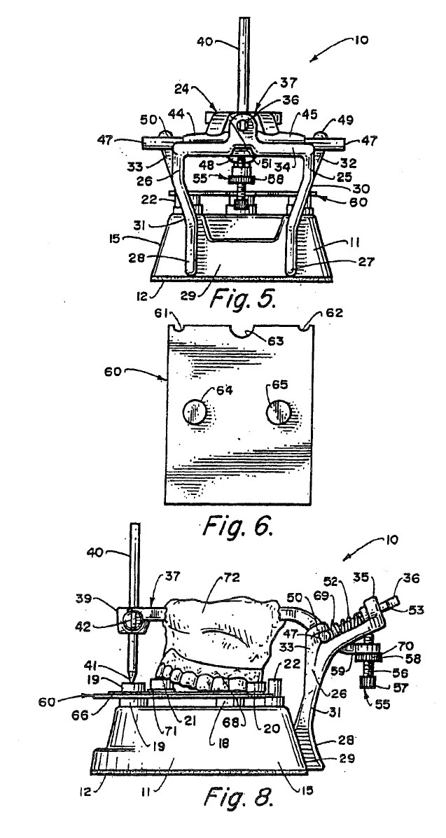

As seen in FIG. 6, a metal plate 60 is provided for use with the articulator 10. Plate 60 is a generally rectangular planar member having cut-out portions at corners 61, 62. As seen particularly in FIG. 4, plate 60 is adapted to rest on top of magnets 19 to 21 (FIG. 1) with plate 60 straddling posts 22, 23 at cut-out portions 61, 62. Of course, magnets 19 to 21 may be removed and the built-in magnets of bosses 16 to 18 will hold the plate 60 in position, since plate 60 is preferably made of magnetizeable steel.

Plate 60 may need a cut-out zone 63 at the rear allowing for screw 55 to enter therein when plate 60 is mounted on base 11 if plate 60 is overly deep. Of course, the overall length of screw 55 may be shortened so as to clear the plate or plate 60 may be moved forwardly on base 11 to allow for clearance. See FIG. 6.

The articulating member 24 may be of brass and the base or support 11 (except for the magnetic material of bosses 16 to 18) may be of a cast resin material. Plate 60 may be of steel. The magnets 19 to 21 and the magnetic material of bosses 16 to 18 may be heavy magnets of samarium cobalt. Guide posts 22, 23 may be of any suitable metallic material as is probe 40. As seen in FIG. 6, other loosely disposed disk-shaped magnets 64, 65, similar to magnets 19 to 21, may be provided on top of plate 60 and, as will be discussed may be placed anywhere on top of plate 60.

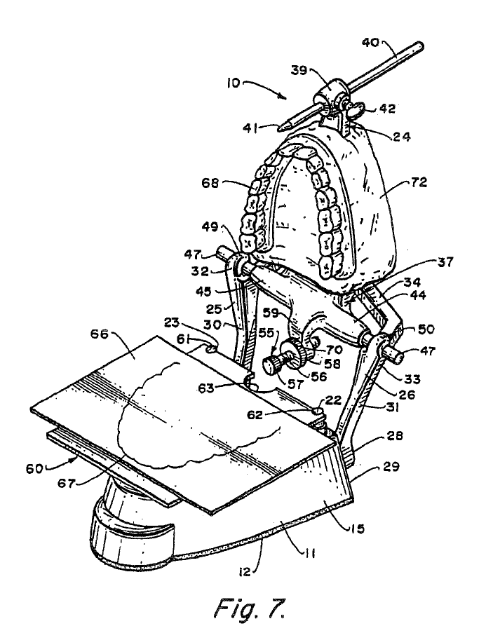

In operation, the apparatus is set up as in FIG. 1, articulating portion 37 shown as raised with a piece of paper 66 (FIG. 7) having indicia 67 thereon relating to the measurements of the occlusal plane of the patient's mouth and other important parameters and measurements. An outline of the patient's preexisting denture, such as his upper denture, may be provided on paper 66. The patient's preexisting upper denture 68 is now placed on the paper 66 (of course, paper 66 can be removed, if desired).

As seen in FIG. 8, magnets, such as magnets 19 to 21 are used on top of plate 60. Magnet 19, for example, is placed under the tip 41 of probe 40 and probe 40 is adjusted, via screw 42, to provide a predetermined height between articulating portion 37 and plate 60.

Magnets 20 and 21 are placed under denture 68 to build it up at the locations illustrated in accordance with the parameters recorded on paper 66. Additionally, one or more shims 71 may be used such as between magnet 21 and plate 60, to provide the desired angular relation to the denture 68 on plate 60. Of course, shims and magnets need not be used if the correct angle is present.

Quick drying plaster of paris or other suitable casting material 72 is now molded onto articulating portion 37, on the portion thereof surrounding opening 38 and in opening 38 to retain in place a newly made cast of the patient's mouth said cast having been made of gypsum or other suitable matter, in the articulator in order to orient said cast in the proposed occlusal plane. In this manner, an upper model of the patient's mouth is generated. The articulating portion 37 is now pivoted downwardly from the FIG. 7 position to the FIG. 8 position. The articulating portion 37 with attached upper model and upper denture may be removed from the articulator 10 and disposed in a conventional casting articulator.

The lower model of the patient's mouth is generated in a conventional manner. Namely, the casting articulator is inverted, the patient's bite registration is placed upon the upper dentures (now in the inverted position), and the lower denture is fitted to the bite registration. Gypsum or other suitable matter is molded to fill between the lower denture and the casting articulator.

Thus with the location of both the upper and lower teeth for the dentures now located, the new dentures can now be made by any technique available to those with skill in the art.

Probe 40 is thus adjusted to make a permanent reference for the incisal length of the new work, and a tracing can be made about the mounted denture to be used as a guide for setting teeth. Screw 57, 58 is used clinically to establish the distance between upper and lower mouth casts in making new dentures. That is, screw 57, 58 can adjust the rear pivotal end of articulating portion 37 with respect to the fixed portion of articulating member 24 thus permitting correlation of the angularity of the upper jaw of a patient with respect to the lower jaw.

It can be seen that there is disclosed an improved apparatus useful in forming dentures, which apparatus aides the dentist to make a more precise fitting denture set quicker and easier, by coordinating his or her plan for the denture with the actual product being made.

It is also seen that while a specific configuration for the hinging of the top to the base, i.e. the articulating member is disclosed herein, other hinge means, both severable and non-severable that permit the accurate measurements required for denture manufacture to be utilized, may be employed herein.

Since certain changes may be made in the above apparatus without departing from the scope of the invention herein involved, it is intended that all matter contained in the above description and shown in the accompanying drawings shall be interpreted as illustrative and not in a limiting sense.

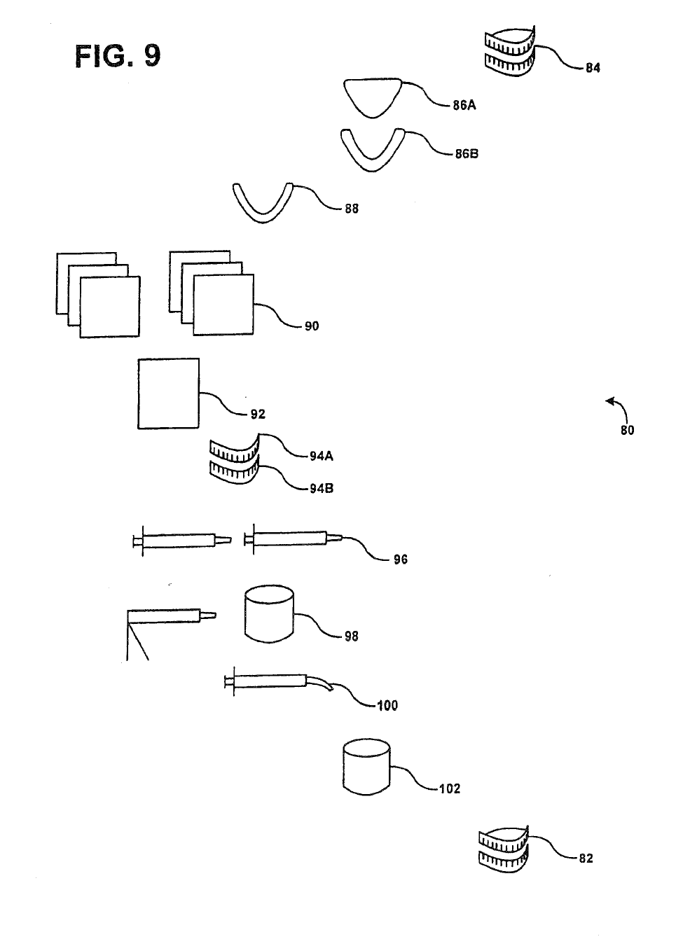

FIG. 9 is a block diagram of a patient kit 80 that is suitable for use with the denture system and method of fabricating dentures. In general, the patient kit 80 includes some or all of the materials to fabricate a set of dentures 82 from an existing set of dentures 84. In a particular example, the patient kit 80 includes one or more of the following: an impression material 86a and 86b; bite registration material 88; dental gypsum 90; tracing plate 92; wax pattern 94a and 94b; fill wax 96; investing materials 98; tooth resin 100; and denture base resin 102.

In a particular example, the patient kit 80 includes the following quantities of the constituents: 3-5 grams of the impression material 86a and 86b, 6-8 grams of the bite registration material 88, and the dental gypsum 90 may include dental plaster and/or dental stone. In a particular example the dental gypsum 90 may include 72 grams of dental stone for each arch (144 grams total) and 54 grams of dental plaster for each arch (108 grams total). The patient kit 80 may further include one tracing plate 92 and one each of the wax pattern 94a and 94b. The patient kit 80 may further include 20-30 grams of the fill wax 96 and 230 grams of the investing materials 98. The resins may include a resin powder polymer and a resin liquid monomer. In a particular example, the tooth resin 100 includes 4 grams of resin powder and 2.2 milliliters (ml) of the monomer and the denture base resin 102 includes 21.2 grams of the resin powder and 15 ml of the monomer. All of the particular weights and volumes described herein are approximate and based upon an average patient anatomy. In other instances, the weights and volumes may be more or less in response to larger or smaller patient anatomies.

The impression material 86a and 86b is utilized to make a mandibular edentulous ridge impression and maxillary edentulous ridge and palate impression. For example the impression material 86a and 86b may be configured in material properties, sizes, shapes and thicknesses that are suitable for use to make the impressions. Suitable impression material may include polyvinylsiloxane (vinyl polysiloxane) wash or putty, polyether, polysulfide (rubber base), silicone, zinc oxide eugenol, hydrocolloid or alginate impression material. Specific examples of suitable impression materials include Super-Dent High-Performance Polyvinylsiloxane Medium Viscosity/Regular Set manufactured by Darby Dental Laboratory of Jericho, N.Y., USA and/or Defend Super Hydrophilic Vinyl Polysiloxane High Performance Medium Body manufactured by MyDent International of Hauppauge, N.Y., USA.

The bite registration material 88 is utilized to determine a relative position of the existing dentures 84 in the patient's mouth and thereby locate the position of the patient's mandibular edentulous ridge relative to the patient's maxillary edentulous ridge. The bite registration material 88 may include any suitable material for registering the patient's bite. Suitable examples of bite registration material include Polyvinylsiloxane (Vinyl Polysiloxane) wash or putty, aluwax, gypsum, wax and/or impression compound. Examples of suitable bite registration material includes those manufactured by Parkell Inc. of Edgewood, N.Y., USA. More particularly, suitable bite registration material includes Blu-Mousse Thixotropic Vinyl Polysiloxane manufactured by Parkell Inc.

The dental gypsum 90 is utilized to fabricate a model of the patient's mandibular edentulous ridge, maxillary edentulous ridge and palate. The dental gypsum 90 may include dental stone and/or dental plaster. In a particular example, the impression material 86 is utilized to generate surfaces that correspond to the patient's mandibular edentulous ridge, maxillary edentulous ridge and palate and the dental gypsum 90 is utilized to generate the corresponding underlying structures.

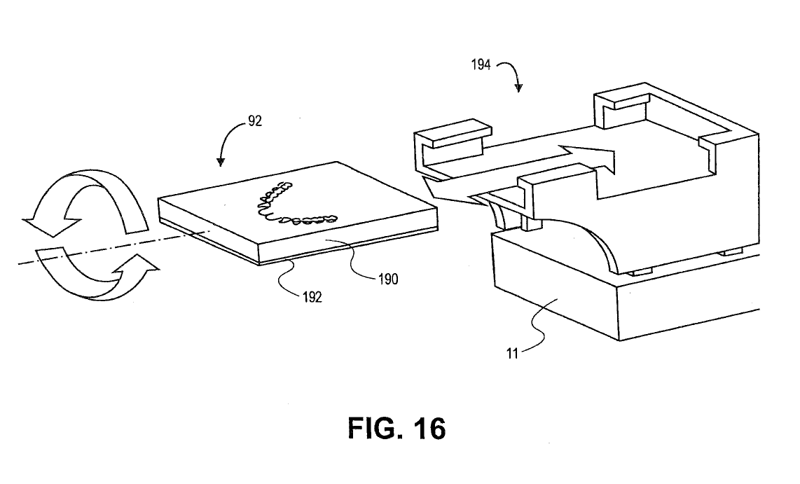

The tracing plate 92 is utilized to trace an arch of the existing dentures 84. In various forms, the upper teeth of the existing denture 84 may be traced. In a particular example, the tracing plate 92 is utilized to trace the upper or maxillary arch of the existing dentures 84. This tracing may be utilized to orient a jaw cast or patient model to a proposed occlusal plane of the new dentures 82. The tracing made of the existing upper denture 84 is subsequently utilized to shape the wax pattern 94. The tracing plate 92 may include any suitable surface or stage upon which the existing dentures 84 may be placed and a tracing may be made upon. The tracing may be marked in any suitable manner such as etched or drawn. In a particular embodiment, the tracing plate 92 is similar to the plate 60 and paper 66 shown in FIG. 7. Another embodiment of the tracing plate 92 is shown in FIG. 16.

The wax pattern 94a and 94b is configured to provide a tooth pattern for the dentures 82. In this regard, the wax pattern 94a and 94b may each include a full or partial arch of teeth and a portion of the gum. In a particular example, the wax pattern 94a is configured to substantially duplicate an upper arch of teeth and a portion of the gum. The wax pattern 94a may be modulated to approximate the arch traced upon the tracing plate 92. In this manner, the tooth pattern for the dentures 82 may be quickly and accurately placed. In conventional denture fabrication, teeth are individually placed to form an arch. This conventional method of tooth placement is time consuming and meticulous. Furthermore, these conventionally positioned teeth often separate subsequently from the denture base. Thus, it is an advantage of embodiments of the invention that the wax pattern 94a and 94b facilitate production of a more structurally sound set of dentures with a reduced amount of labor.

The wax pattern 94a and 94b is fabricated from any suitable material. Suitable materials include wax and the like. In a particular example, the wax pattern 94a and 94b include a pink wax base and white wax teeth. More specifically, suitable materials for the wax pattern 94a and 94b include Shur Wax X-Hard manufactured by Heraeus Kulzer, Inc. of South Bend, Ind. 46614, USA for the gums and a custom blended wax composition for the teeth. The custom wax composition includes 100 parts by weight refined beeswax, 20 parts by weight carnuba wax, and 20 parts by weight paraffin.

The fill wax 96 is configured to fill in any gap between the wax pattern 94a and 94b and the model of the patient's mandibular edentulous ridge, maxillary edentulous ridge and palate. The fill wax 96 may include any material suitable for filling the gap. Examples of suitable materials include wax or wax-like material, putty, modeling clay, resins, plastics, expandable foam, etc.

The investing materials 98 are utilized to generate a mold to fabricate the dentures 82. The investing materials may include any materials suitable for molding dentures. In general, the investing materials 98 may include stone investment materials such as gypsum, silicone, hydrocolloid, and/or the like. In a particular example, the teeth of the wax pattern 94a and 94b are investment cast in silicone investment material such as Defend Super Hydrophilic Vinyl Polysiloxane High Performance Medium Body Regular Set manufactured by MyDent International of Hauppauge, N.Y., U.S.A. and the like. Some or all of the remainder of the investment cast may include hydrocolloid material.

The tooth resin 100 is configured to approximate the color and material characteristics of natural teeth to the extent possible. In this regard, the tooth resin 100 may be essentially white or ivory in color and, when hardened, sufficiently hard and tough enough to serve as denture teeth. Examples of suitable tooth resin include acrylic denture teeth resins. More specifically, suitable tooth resin include Hi-I® Hi-Impact denture material powder manufactured by Fricke Dental International, Inc. of Villa Park, Ill. 60181, USA with Nature-Cryl Pour-N-Cure Acron MC/R Self Cure Repair and Reline Liquid manufactured by GC America Inc. of Alsip, Ill. 60803, USA.

The denture base resin 102 is configured to approximate the color and material characteristics of natural gums to the extent possible. In this regard, the denture base resin 102 may be essentially pink in color. Examples of suitable denture base resin include self/auto-cure acrylic resin. More specifically, suitable denture base resins include Lucitone Fas-Por powder/liquid manufactured by Dentsply International of York, Pa. 17405, USA.

In other embodiments, the patient kit 80 may include a subset of the components shown in FIG. 9. For example, to generate clinical impressions and/or records for a patient with the existing set of dentures 84, the patient kit 80 may include: the impression material 86a and 86b; bite registration material 88; dental gypsum 90; and the tracing plate 92.

In another example, to generate clinical impressions and/or records for a patient without the existing set of dentures 84, the patient kit 80 may include: the impression material 86a and 86b; bite registration material 88; dental gypsum 90; tracing plate 92; wax pattern 94a and 94b; and fill wax 96. Optionally, the patient kit 80 may further include a set of wax rims. The wax rims, if present, are utilized in a conventional manner to generate mock-up or template of a maxillary and/or mandibular arch for the patient.

In yet another example, given the clinical impressions and/or records, to generate the set of dentures 82 from an existing set of dentures 84, the patient kit 80 may include: the wax pattern 94a and 94b; fill wax 96; investing materials 98; tooth resin 100; and denture base resin 102.

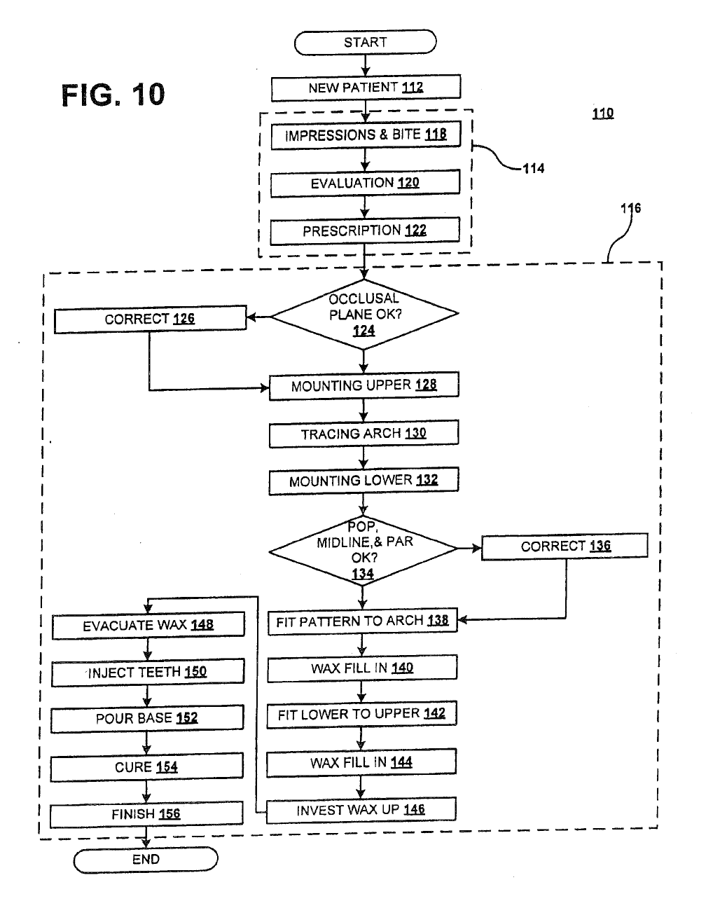

FIG. 10 is a flow diagram for a method 110 of fabricating the dentures 82 according to an embodiment of the invention. Prior to initiation of the method 110, a variety of preparation may occur. Examples of pre-fabrication preparation may include one or more of: acquire a suitable fabrication device such as the articulator 10, a casting articulator, investment casting device, and the like; preparing a fabrication facility; acquire fabrication materials such as the patient kit 80; and the like. As shown in FIG. 10, the method 110 is initiated at step 112 in response to receiving a patient with the existing dentures 84. If the patient doesn't have existing denture 84, after making stock tray impressions of the mouth with alginate, or other suitable mouth impression material and dental stone models have be created, immediate wax rims are fabricated using base plate wax. The wax rims are used as surrogates for absent existing dentures. In a particular example, Heraeus Kulzer Modern Materials Shur Wax X-Hard may be utilized to fabricate a wax up of the dentures. Following wax denture fabrication, the wax up may be investment cast at step 146.

There are, in general, two phases of denture manufacture: 1) clinical impressions/records and evaluation at step 114; and 2) laboratory denture set-up and fabrication process at step 116. Generally, the clinical impressions and evaluation are performed in the presence of the patient. It is an advantage of embodiments that step 114 may be performed quickly and without multiple steps that involve the patient. The step 116 is typically performed without the patient. Steps 126 to 136 are performed with the existing denture 84 in about one hour or less. It is an advantage of embodiments that the existing denture or dentures 84 are no longer needed following step 136. As such, the patient may leave the office with the denture 84.

At step 114, clinical impressions/records and evaluations are performed. For example, at step 118, impressions can be taken in the patient's existing denture 84 using the impression material 86. For example, a mandibular edentulous ridge impression and maxillary edentulous ridge and palate impression is made by placing the impression material 86a and 86b on the denture 84 and placing the denture 84 in the patient's mouth. In addition a bite registration is done with the bite registration material 88 by placing the bite registration material 88 on the lower occlusal surface of the denture 84 and guiding the patient into their correct bite.

At step 120, the patient's existing denture 84 may be evaluated. For example, the occlusal plane (“OP”) of the denture 84 within the patient's mouth may be evaluated. In addition, the midline, lip support (“LS”), incisal length (“POP”), vertical dimension (“PAR”), and the like of the existing denture 84 may be evaluated while in the patient's mouth. At step 122, a prescription based on the evaluation is generated. For example if it is determined at step 120 that the OP is tilted, the prescription is generated to correct any undue tilt in the OP.

At step 124 it is determined if the OP is acceptable. For example, if the OP is determined to be acceptable at step 120 then the upper denture 68 (shown in FIG. 8) is mounted at step 128. If, at step 120, it is determined that the OP is unacceptable then the attitude or angle of the upper denture 68 is corrected at step 126.

At step 126, the OP is corrected according to the prescription generated at step 122. For example in response to the prescription indicating a 3|3+2 correction (Palmer Notation), a 2 millimeter (mm) shim is disposed below the upper left cuspid of the denture 68. Of note, correction may be performed in a “magnets up” (shown in FIG. 8) or “magnets down” (shown in FIG. 9) configuration. In another example, the upper denture 68 is placed upon a yielding surface, such as the yielding surface 190 shown in FIG. 16, and the right side of the upper denture 68 is pressed 2 mm into the yielding surface.

At step 128, the upper denture 68 is mounted to the articulator 10. For example, a sufficient amount of the dental gypsum 90 is applied to the upper denture 68 to adhere the upper denture 68 to the articulating portion 37 (shown in FIG. 8). Care is taken to slope the dental gypsum 90 away from the borders of the upper denture 68.

At step 130, the dental arch of the upper portion 68 is traced upon the tracing plate 92. For example, a pencil or scribing tool is utilized to outline the upper denture 68 upon the tracing plate 92. In various embodiments, an indexing mark or the incisal reference pin 40 may be utilized to later verify proper positioning of the dentures.

At step 132, a lower denture of the existing dentures 84 is mounted in proper bite alignment to the upper denture 68. For example, the mounted upper denture is placed in a casting articulator, the bite registration taken at step 118 is aligned upon the upper denture 68 (the upper denture and mouth cast may be inverted to facilitate this procedure) and the lower denture aligned thereto. In addition, a sufficient amount of the dental gypsum 90 is applied to the lower denture and mouth cast to adhere the lower denture to the base of a casting articulator. Care is taken to slope the dental gypsum 90 away from the borders of the lower denture. Once the dental gypsum has hardened, the dentures 84 may be removed from the articulator 10, cleaned and returned to the patient. At this stage, a model of the patient's mandibular edentulous ridge, maxillary edentulous ridge and palate have been generated. The upper model is then removed from the casting articulator and returned to the articulator 10.

At step 134 it is determined if the midline, POP, and PAR is acceptable. For example, if each of the midline, POP, and PAR is determined to be acceptable at step 120 then, at step 138, a wax pattern corresponding to the upper denture 68 is formed to the arch. If, at step 120, it is determined that any one or more of the midline, POP, and PAR is unacceptable then the one or more of the midline, POP, and PAR is corrected at step 136.

At step 136, the one or more of the midline, POP, and PAR is corrected according to the prescription generated at step 122. For example, in response to the prescription indicating a POP+1 correction, the POP adjustment screw, such as the screw 55 shown in FIG. 8, is adjusted to raise the articulating portion 37 (and thus the Maxillary model) 1 mm. If midline correction is indicated, the midline correction prescription is noted at step 136.

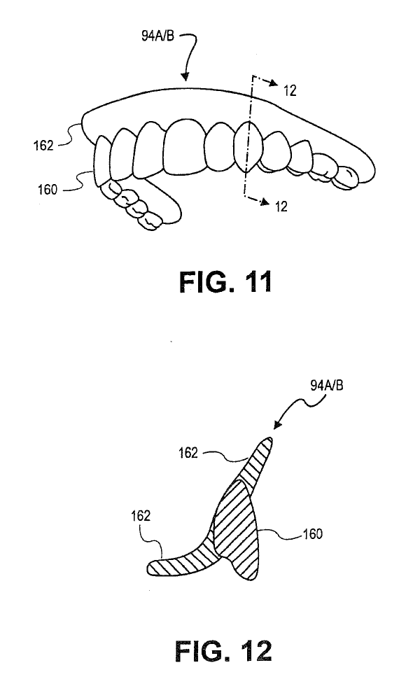

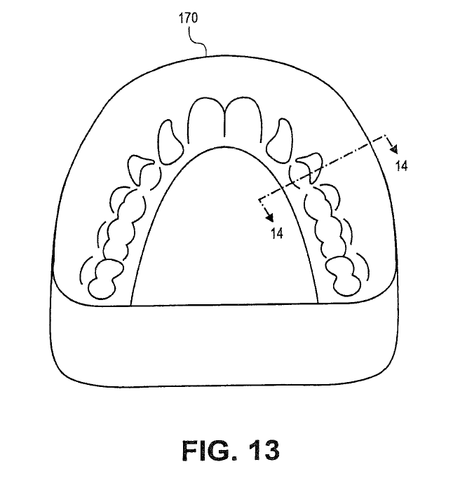

At step 138, the wax pattern 94a is formed to the arch traced at step 130. For example, the wax pattern 94a is warmed to soften the wax and adjusted to approximate the shape of the tracing. A particularly suitable wax pattern 94a is shown in FIGS. 11 and 12. It is an advantage of embodiments that a full arch of teeth may thusly be positioned in a small fraction of the time required by conventional dental fabrication processes. Midline correction, if indicated, is performed at step 138 by shifting the formed arch the prescribed direction and amount.

At step 140, liquid or semi-liquid wax may be injected to fill in between the wax pattern 94a and the Maxillary portion of the model. In addition, a film of wax may be placed upon a palate portion of the model.

At step 142, the wax pattern 94b is formed to the wax pattern 94a. For example, the mounted upper model with the wax pattern 94a is placed in the casting articulator and the casting articulator is inverted. The wax pattern 94b is warmed to soften the wax and adjusted to mate with the wax pattern 94a.

At step 144, liquid or semi-liquid wax may be injected to fill in between the wax pattern 94b and the Mandibular portion of the model. In various embodiments, an indexing mark may be utilized to later verify proper positioning of the dentures. At this stage, the geometry of the “wax up” is essentially set and the surfaces are smoothed.

At step 146, an investment “wax up” is performed in a conventional manner. For example the newly fabricated wax ups corresponding to the upper and lower dentures may be placed, individually in pour flasks. Optionally, a silicone impression material may be utilized to capture the finer details of the teeth. In addition, a sufficient amount of the hydrocolloid investing materials 98 may be poured into the pour flask to surround the wax ups.

At step 148, the investment wax up is evacuated in a conventional manner. For example, the wax up is heated or subjected to water heated sufficiently to melt the wax if gypsum investment is utilized.

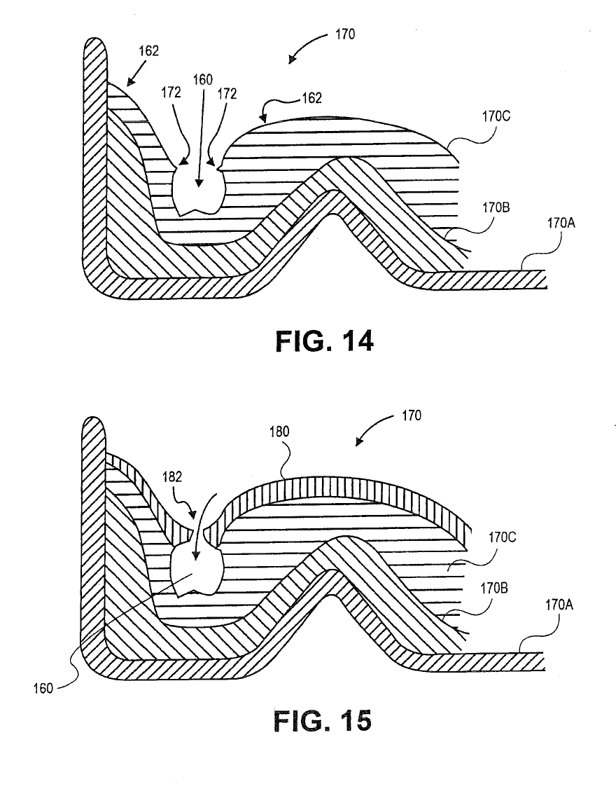

At step 150, the tooth resin 100 is injected into a tooth portion of the investment cavity. It is an advantage of an embodiment that the wax pattern 94a and 94b include a channel formed at the interface between the teeth and the gum portions. A mold suitable to form the wax pattern 94a and 94b is shown in FIGS. 13-15. Of particular note, a ridge that forms the groove in the wax pattern 94a and 94b is shown in FIG. 14. This groove forms a corresponding ridge in the investment cavity. This ridge facilitates filling the tooth portion with the tooth resin 100 by forming a clear delineation between the tooth portion and the gum portion. In addition, the tooth resin 100 may be “flash cured” to mitigate or reduce migration of the tooth resin 100 into the gum portion of the investment cavity. In a particular example, the tooth resin 100 may be flash cured by directing a stream of heated air there upon. In this manner, the consistency of the tooth resin 100 may firmed or thickened somewhat to retain the tooth resin 100 within the tooth portion of the investment cavity.

At step 152, the mold containing the investment cavity is re-assembled in the pour flask and the denture base resin 102 is introduced or poured therein.

At step 154, the tooth resin 100 and denture base resin 102 may be cured in the investment cavity to generate the dentures 82. Depending upon the resin utilized, the curing may be performed by microwave heating, pressurized heat, heated water bath or the like. In a particular example, the filled pour flask may be disposed within a pressure chamber for a suitable duration.

Following the step 154, the dentures 82 may be removed from the mold and any excess material may be removed.

FIG. 11 is a perspective view of a wax arch suitable for use according to an embodiment of the invention. As shown in FIG. 11, the wax pattern 94a/94b includes simulated teeth or a tooth portion 160 and simulated gums or a base portion 162. According to an embodiment, the tooth portion 160 includes a general appearance of a natural tooth. That is, the tooth portion 160 includes one or more characteristic of a natural tooth. In general, characteristics of a natural tooth include size, shape, color, sheen, translucence, and the like. Similarly, the base portion 162 includes a general appearance of natural gums. It is an advantage of the wax pattern 94a/94b that patients may be better able to visualize the dentures 82 given a more natural appearance of the wax up. In contrast, a convention wax up with one color and/or an unnatural appearance may be unappealing to a patient.

FIG. 12 is a cut away view 12-12 through the wax pattern 94a/94b according to an embodiment. As shown in FIG. 12, the tooth portion 160 may be partially encased in the base portion 162. In addition, the tooth portion 160 extends substantially through the wax pattern 94a/94b. In this manner, color from the base portion 162 is essentially precluded from showing through in the tooth portion 160. Due to the translucence of the wax, the base portion 162 may show through a relatively thinner tooth portion 160.

FIG. 13 is a perspective view of a mold 170 suitable for use according to an embodiment of the invention. As shown in FIG. 13, the mold 170 includes an impression that generally corresponding to the wax pattern 94a/94b. In addition and as shown in greater detail in FIG. 14, the mold 170 includes a groove representing the gum-tooth line of demarcation.

FIG. 14 is a cut away view 14-14 through the mold 170 according to an embodiment. As shown in FIG. 14, the mold 170 includes a ridge 172 to delineate the tooth portion 160 from the base portion 162. The ridge 172 facilitates generating the wax pattern 94a/94b by providing a pronounced barrier. As tooth colored wax is introduced to the mold 170, the ridge 172 retains the tooth color wax in the tooth portion 160. Once the tooth colored wax has solidified to the point at which mixing is minimized, gum colored wax may be applied to the base portion 162.

The mold 170 may be essentially unitary or monolithic or may include a variety of layers. In a particular example, the mold 170 may include a tray 170A, base layer or patternform buttress 170B, and patternform 170C. These layers may include any suitable material such as, for example, metal, plastic, plaster, silicone, and the like.

FIG. 15 is a cut away view 14-14 through the mold 170 according to another embodiment of the invention. As shown in FIG. 15, the mold 170 includes an insert 180. The insert 180 includes a fill hole 182 and, together with the mold 170, the insert 180 generates a void corresponding to the tooth portion 160. In use, the tooth color wax is introduced to the mold 170 through the fill hole 182 and allowed to solidify. Thereafter, the insert 180 may be removed from the mold 170 and gum colored wax may be introduced to the mold 170.

FIG. 16 is a perspective view of the tracing plate 92 and a stage suitable for use with an embodiment of the invention. As shown in FIG. 16, the tracing plate 92 includes a yielding surface 190 and a tracing surface 192. The yielding surface 190 provides a surface that the existing set of dentures 84 may be pressed into to correct defects such as, for example, pitch, yaw, roll, curvature, and the like, in the existing set of dentures 84. To illustrate, patients often have a preferred side of their mouth to chew food on. Over time, the preferred side may be worn down to a greater extent than the other side. Left uncorrected, this uneven wear may result in jaw related problems for the patient. According to an embodiment of the invention, this and other such defect may be corrected by observing, measuring, and/or sensing the defective denture in the patient's mouth and determining a corrective prescription. The attitude of the denture 84 may be adjusted on the tracing plate 92 by pressing the denture 84 into the yielding surface 190. The yielding surface 190 may include any suitable material. In general, suitable materials for the yielding surface 190 include formable, crushable, malleable, or resilient materials. Particular examples of suitable materials for the yielding surface 190 include expanded polymer foam such as Styrofoam®, putty, modeling clay, and the like.

The tracing surface 192 provides a substantially hard writing or marking surface suitable for tracing an outline of a dental arch for the dentures 84. In a particular example, the tracing surface 192 may include paper, cardstock, or the like. In other examples, the tracing surface 192 may include a relatively thin, scratchable layer that may be selectively scratched away to reveal an underlying layer having a contrasting color.

In addition, as shown in FIG. 16, the tracing plate 92 may be retained upon the articulator main base 11 by a stage 194. In a preferred example, the tracing plate 92 may be retained by the stage 194 with the yielding surface 190 or tracing surface 192 facing upward.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of generating a set of dentures from an existing set of dentures, the method comprising the steps of:
sensing an existing denture for a patient, wherein the denture corresponds to one or more of a mandibular edentulous ridge, maxillary endentulous ridge, and palate of the patient;
generating a model of the one or more of the mandibular edentulous ridge, maxillary endentulous ridge, and palate;
modulating a wax arch of teeth in response to a sensed arch of the existing denture;
generating a wax up corresponding to the existing denture by filling a gap between the wax arch and the model; and
fabricating a new denture corresponding to the existing denture by investment casting the wax up.

2. The method according to claim 1, further comprising the steps of:
evaluating the patient; and
modulating the step of generating the wax up in response to the evaluation.

3. The method according to claim 2, further comprising the step of:
evaluating an occlusal plane of the patient, wherein the occlusal plane is an imaginary plane formed by occlusal surfaces of the patient's teeth when the patient's jaw is closed.

4. The method according to claim 2, further comprising the step of:
evaluating a midline of the existing dentures.

5. The method according to claim 2, further comprising the step of:
evaluating a lip support provided by the existing dentures.

6. The method according to claim 2, further comprising the step of:
evaluating an incisal length of the existing dentures.

7. The method according to claim 2, further comprising the step of:
evaluating a vertical dimension of the existing dentures.
